(19) United States
(12) Patent Application Publication
(10) Pub. No.: US 2002/0187285 A1
(43) Pub. Date: Dec. 12, 2002

(54) Confetti with photographic imagery on its surface

(75) Inventors: Geoffery Scott Mitchell, Los Gatos, CA (US); Christopher Paul Burmester, Oakland, CA (US); Ruth M. Lassman, Mountain View, CA (US); Corinne Wayshak, Los Altos, CA (US)

Correspondence Address: Jonathan O. Owens, HAVERSTOCK & OWENS LLP, 162 North Wolfe Road, Sunnyvale, CA, 94086, US

(73) Assignee: confoti, inc.

(21) Appl. No.: 10/163,282

(22) Filed: Jun. 4, 2002

Related U.S. Application Data
(60) Provisional application No. 60/296,206, filed on Jun. 5, 2001.

(51) Int. Cl. G09F 17/00

(52) U.S. Cl. 428/7; 428/906; 156/249

(57) ABSTRACT

Customized confetti and a method for producing customized confetti are disclosed in which customized images are transferred onto one or more faces of the confetti. Images from a set of images are selected and then transferred onto material, which is then cut into small confetti-like pieces. Electronically generated representations of confetti for display on electronic display devices is also disclosed.

### RELATED APPLICATIONS

This application claims priority under 35 U.S.C. §119(e) of the co-pending U.S. provisional application Serial No. 60/296,206 filed on Jun. 5, 2001, and entitled “CONFETTI WITH PHOTOGRAPHIC IMAGERY ON ITS SURFACE.” The provisional application Serial No. 60/296,206 filed on Jun. 5, 2001, and entitled “CONFETTI WITH PHOTOGRAPHIC IMAGERY ON ITS SURFACE” is also hereby incorporated by reference.

### FIELD OF THE INVENTION

The present invention relates to decorative and personally expressive materials. More particularly, the present invention relates to the design and manufacture of decorative and personally expressive confetti that incorporates customized images.

### BACKGROUND OF THE INVENTION

Confetti is widely used in many ways. For example, it can be thrown into the air in celebration of a noteworthy event, such as a wedding or a parade; it can be spread across a floor or a tabletop to create a festive mood; it can be placed in cards and letters, or used as a packaging material in gifts; and it can be collected to form a mosaic. Confetti can be used in these and many other ways, limited only by one's imagination.

Confetti may be produced in several ways. For example, it can be produced by punching holes in colored paper or cardboard. It can be produced by shredding paper. Or it can be produced by cutting colored paper in the shape of animals, bells, stars, or other images associated with celebrations. Confetti is generally mass produced and comes in a variety of shapes, colors, and aerodynamic properties.

There are many patents that teach different aspects of confetti, including its type, design, shape, handling, manufacture, packaging, and delivery; other patents teach products that incorporate confetti into their design or manufacture. Exemplary of these teachings are Patent Number WO 152962 to John L. Vandenberg et. al., which teaches a type of confetti made from reflective film; Great Britain Patent Number GB 1103389 to William H. Hale, which teaches a type of water soluble confetti; and Great Britain Patent Number GB 2200050 to Steven J. Teasdale et. al, which teaches an edible type of confetti.

Other exemplary confetti patents teach a specific design or shape of confetti that benefits from a specific decorative design or aerodynamic property by virtue of its shape. Examples of such patents include U.S. Pat. No. 5,352,148 to James O. Watkins, which teaches an elongated type of confetti that yields a distinctive “fluttering” as it floats down in the air after being distributed; U.S. Pat. No. D385,824 to Ardina K. Sterr et. al., which teaches a specific ornamental leaf shaped design; U.S. Pat. No. 5,911,805 to Ardina K. Sterr et. al., which teaches a method of manufacture and a specific shape of confetti with an interior cut out that yields visually pleasing flight patterns; and Great Britain Patent Number GB 2275202 to D. Cruze Anne Marie Joyce, which teaches confetti in the shape of the letters of the alphabet.

Other patents teach ways to handle and manufacture confetti. For example, U.S. Pat. No. 4,955,412 to Younts et. al. teaches a method of handling confetti in a manufacturing process, specifically, a method and apparatus for simultaneously injecting air and confetti into a balloon. Several patents also teach methods of manufacturing confetti. Exemplary of this are U.S. Pat. No. 5,797,304 to Ardina K. Sterr et. al., which teaches a method of cutting multiple shaped stacks of confetti; Japanese Patent Number 6105966 to Shudo Kazuhiko, which teaches an inexpensive method of manufacturing confetti to accompany karaoke; and U.S. Pat. No. 6,258,447 to Weder et. al., which teaches a method of manufacturing “decorative shredded material,” including confetti, to yield a complete portion of a repeated pattern on each shred of material.

Still other confetti patents teach ways of packaging the confetti so that it might be more effectively delivered or distributed by hand or by other mechanisms. Exemplary of this is U.S. Pat. No. 5,643,042 to James O. Watkins, which teaches a form of stacked confetti that allows a resulting composite mass to be projected high into the air.

Delivery mechanisms for distributing or broadcasting confetti are also taught in other patents. For example, U.S. Pat. No. 5,433,644 to Peter S. C. Cheng, which teaches a confetti “cannon” for firing confetti into the air; U.S. Pat. No. 5,556,319 to James O. Watkins, which teaches a handheld wand for casting confetti; U.S. Pat. No. 5,015,211 to Tyrone J. Reveen, which teaches an envelope that, when ruptured, uses chemical propellants to expel the contained confetti; and European Patent Number 1,114,663 to Peter S. C. Cheng, which teaches the manufacture of an inverted pocket filled with confetti that, when the enveloping pocket is ruptured, ejects the confetti.

Still other inventors make use of confetti in the creation of inventions or products that incorporate confetti in their design or manufacture, or in inventions that are designed to house or display confetti. For example, U.S. Pat. No. 5,197,213 to Mary E. Borden teaches a decorative framing border that can house a myriad of appearance altering items, including confetti; U.S. Pat. No. 5,199,745 to Lawrence J. Balsamo teaches a greeting card containing a tissue paper confetti package that ruptures and spews confetti when the card is opened; and U.S. Pat. No. 5,655,325 to James O. Watkins teaches a banner that, when unfurled, releases pre-packaged confetti into the air.

Confetti is generally popular because its requirements are few: it needs to be small, lightweight, and generally colorful. As discussed above, conventional confetti can be cut into interesting shapes and sizes, and shaded with festive colors. But conventional confetti is limited in its ability to display personally expressive images.

While the advancements described above teach manufacturing, use, process, form factor, and numerous other aspects of confetti, the prior art does not teach confetti customized with images, which can be used as a form of personal expression.

### SUMMARY OF THE INVENTION

The present invention is confetti or confetti-like materials customized with images, which can be used for personal expressions including, but not limited to, being thrown into the air in celebration of a noteworthy event, such as a wedding or a parade; spread across a floor or a tabletop to create a festive mood; placed in cards and letters; used as a packaging material in gifts; kept as decorations or mementos; collected to form a mosaic; attached to banners and signs; attached to or displayed on party goods, such as napkins, cups, and other items on which personally expressive items may be viewed; used in electronically generated displays, such as in animated greeting cards sent as attachments to electronic mail; or used in many other ways, limited only by one's imagination.

In one embodiment of the present invention, a customized image is transferred to a face of a bit of material. The customized image may be a photographic image to be used at a wedding, wedding shower, birthday, birth, baby shower, anniversary, retirement, graduation, house warming, holiday or any other event or occasion. The customized image can have these and many other personally expressive uses.

The bit of material is thin and has a confetti-like form factor so that it can, for example, be thrown into the air in a celebratory gesture, spread over a table top, used to decorate a surface, or used in any manner of personal expression. Alternatively, the bit of material has a greater thickness to be more durable. The present invention includes bits of material with any thickness, so long as it can bear a customized image. In the preferred embodiment the bit of material is a piece of confetti.

The present invention also includes electronically generated confetti bearing customized imagery. The electronically generated confetti can be statically or dynamically displayed on an electronic display device as, for an example, an attachment to an electronically transmitted greeting.

The present invention also includes a process for generating customized confetti. This process includes selecting raw photographic images, generating processing instructions for manipulating the raw photographic images, transmitting the processing instructions and raw photographic images to a confetti processor, using the transmitted processing instructions and raw photographic images to generate processed photographic images, transferring the processed photographic images onto a material, and cutting the material into confetti-like pieces or bits of material. The processing instructions preferably include instructions for cropping the images to remove non-essential portions of the raw photographic images and adding any desired textual messages to the raw photographic images.

### BRIEF DESCRIPTION OF THE DRAWINGS

FIG. 1 illustrates a customized piece of confetti with an image on a face according to one embodiment of the present invention.

FIG. 2 illustrates a collection of the customized pieces of confetti shown in FIG. 1.

FIG. 3a illustrates a customized piece of confetti with a first photographic image on a first surface according to one embodiment of the present invention.

FIG. 3b illustrates the customized piece of confetti shown in FIG. 3a, with a second photographic image on a second surface.

FIG. 4a illustrates a customized piece of confetti with a photographic image on a first surface according to one embodiment of the present invention.

FIG. 4b illustrates the customized piece of confetti shown in FIG. 4a, with a textual image on a second surface.

FIG. 5a illustrates a customized piece of confetti with a photographic image on a first surface according to one embodiment of the present invention.

FIG. 5b illustrates the customized piece of confetti shown in FIG. 5a, with no image on a second surface.

FIG. 6 illustrates a collection of customized pieces of confetti, each bearing a different image.

FIG. 7 illustrates a collection of customized pieces of confetti, each bearing a different image or no image.

FIG. 8 illustrates a customized piece of confetti with a textual image on its surface.

FIG. 9 illustrates a collection of the customized pieces of confetti shown in FIG. 8.

FIG. 10 illustrates a collection of confetti including confetti having a photographic image, a textual image, a photographic and textual image, or a color with no image on the face of each piece of confetti.

FIG. 11 illustrates a collection of confetti including confetti having photographic images, textual images, photographic and textual images, or a color with no image on the face of each piece of confetti.

FIG. 12 illustrates a selection/command processor and confetti processor in accordance with the present invention.

FIG. 13 illustrates a flowchart depicting the steps in producing customized confetti in accordance with the present invention.

FIG. 14 illustrates an electronic display device displaying an electronically generated collection of confetti having photographic images, textual images, photographic and textual images, or a color with no image on the face of each piece of electronically generated confetti.

### DETAILED DESCRIPTION OF THE INVENTION

In a first aspect of the invention, photographic imagery is selected in thematic groupings. The imagery is prepared for transfer onto a material that is cut into pieces with a confetti form factor.

The physical dimensions of confetti with photographic images according to the present invention is small enough to be confetti-like in nature and use, but large enough to bear a photograph that can be easily viewed and suitable to an event, individual, or purpose, among other things. The physical dimensions of the confetti of the present invention is between ¼ inch and 2 inches per side or diameter, but alternatively any size material used as confetti is considered an instance of the invention.

The confetti with photographic images of the present invention may also appear in a range of shapes. The shape of the pieces of confetti with photographic images of the present invention may include, but is not limited to, photo-style rectangles, squares, circles, hearts, triangles, stars, bells and other geometric and non-geometric shapes.

The confetti with photographic images of the present invention may have photographic imagery on one face or on both faces; or in the instance of three-dimensional confetti, the image may appear on any or all surfaces in three-dimensional space.

The imagery may also appear on a transparent or translucent piece of material, where the photographic image is displayed on one face but is seen through a transparent or translucent media on the other face. The photographic image may also be a hologram.

When the photographic imagery is on two faces, one face may bear individual photographic elements, but the “back” face may bear smaller pieces of a larger photographic image that can be formed by arranging the pieces of the invention in a puzzle-like fashion; or one face may bear an individual photographic element, but the alternate face may have messaging displayed on it.

In the process of the invention, a system and method allows for the conveyance, storage, selection, and manipulation of a set of images, digital or otherwise, to prepare the imagery for use on the confetti. Through this process, an end user can select a personalized set of photographs or stock photographs, which can then be cropped or digitally modified in preparation of their production into confetti. Through this process the end purchaser will acquire a collection of photographic confetti with personally suitable imagery.

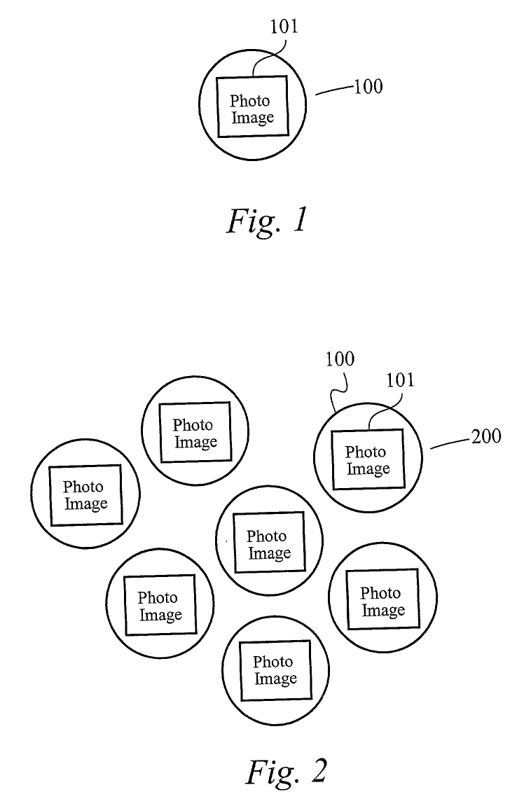

FIG. 1 illustrates one embodiment of the present invention. FIG. 1 shows a bit of material 100 in the shape of a circle and having a photographic image 101 displayed on its face. The term bit of material is used herein to describe material having a small form factor, including confetti, of all shapes. In one embodiment, the bit of material 100 is of substantial weight so that it can be picked up and held easily and pleasingly lie well on surfaces that it decorates.

Preferably, the bit of material 100 is made of any lightweight material, such as paper having a basis weight (the weight of 500 sheets of 17″×22″ paper) of between 5 and 30 pounds. Alternatively, the bit of material 100 can be made of any lightweight material, such as a tissue paper, a photo-quality paper, a polymeric film, a metallic foil, a translucent material so that an image can be viewed from both sides of the bit of material 100, or any material suitable for displaying a photographic image.

Preferably, the bit of material 100 is small enough to have many generalized uses, including uses of personal expression, such as being thrown into the air in a celebratory manner so that it later flutters to the ground; tucked within a small area such as in a wallet or a locket; included in a collage; included in correspondence; used as augmented packing material, or as a building material for other uses such as art pieces or mosaics; used to decorate a surface or suspended as in a mobile; or in any other appropriate manner. The bit of material 100 is also preferably large enough so that an image can be displayed on it. In the preferred embodiment the bit of material 100 is between approximately ¼ inch and 2 inches on a side and thus has a surface area of no more than approximately four square inches. It will be appreciated, however, that alternatively bits of material or confetti having a surface area of other dimensions would also be within the scope of this invention.

The present invention also contemplates electronically generated displays of confetti and materials in the form factor of confetti. For example, confetti and materials in the form factor of confetti may be displayed on an electronic display device, such as an animated electronic greeting card that displays photographic and other personally expressive imagery. The imagery may include, but is not limited to, photographic imagery in the form factor of confetti in digital animation or film. It will be apparent to those skilled in the art that the electronic imagery in the form factor of confetti may be displayed in a variety of ways.

In FIG. 1, the image 101 displayed on the face of the bit of material 100 can be any appropriate customized image including a photograph, graphic, text, icon, or logo. In the embodiment shown in FIG. 1, the bit of material 100 has a photograph 101 displayed on its surface. The photograph 101 may be associated with a particular event. For example, at a wedding the photograph 101 may be one in a series of photographs depicting the couple's courtship. The term customized image is used herein to describe an image that has been selected and/or modified in shape, size, content, or in any other manner so as to be personally expressive.

In FIG. 1, the bit of material 100 is in the shape of a circle, but it should be understood that the bit of material 100 may be of any shape. For example, the bit of material 100 may have a geometric shape, such as a circle, square, triangle, or rectangle; it may have a fanciful shape, such as a bell, heart, or star; or it may have a non-geometric shape that includes all shapes that are neither fanciful nor geometric.

The bit of material 100 may have an adhesive backing or a magnetic backing attached to a second face so that it can be attached to a wall, a cabinet, or any other surface. In this manner it can be more readily displayed.

While FIG. 1 depicts a bit of material 100 having an image on only one face, as described in more detail below, the bit of material 100 may have an image on a second face. Furthermore, while the embodiment of the image 101 shown in FIG. 1 covers only a portion of a face of the bit of material 100, preferably the image 101 covers the entire face of the bit of material 100. And while FIG. 1 depicts the bit of material 100 as a two-dimensional object, the bit of material 100 may be a substantially three-dimensional object. A three-dimensional bit of material (not shown) may be generated, for example, by attaching four bits of material 100 in a tetrahedral fashion. As will be apparent to those skilled in the art, there are other ways of generating a three-dimensional object bearing images.

FIG. 2 depicts a collection 200 of bits of material 100. The collection 200 may be used for a myriad of purposes, including decorating a surface, celebrating, or commemorating an event. The collection 200 may also be used as small form factor cropped photographs that are used as a raw material for creating another craft object, such as a collage or mosaic. FIG. 2 depicts bits of material 100 having the same image 101 displayed on a face of each bit of material 100. While FIG. 2 depicts seven bits of material 100, a collection of bits of material may include more or fewer bits of material 100. Furthermore, while FIG. 2 depicts all of the bits of material having the same size and shape, it will be apparent to those skilled in the art that a collection 200 may include bits of material 100, such as confetti, of different sizes, shapes, and dimensions, and, as discussed below, with different images displayed on them.

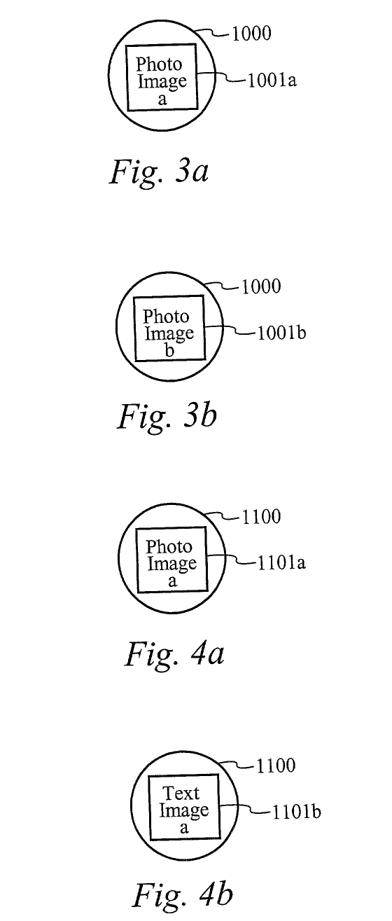

FIGS. 3a-b, 4a-b, and 5a-b illustrate several bits of material in accordance with the present invention.

FIG. 3a depicts a first surface of a bit of material 1000, displaying a first photographic image 100a. FIG. 3b depicts a second surface of the bit of material 1000 shown in FIG. 3a. The second surface displays a second photographic image 1001b, which may be different from the first photographic image 1001a or the same as the first photographic image 1001a. While the photographic images 100a and 1001b are shown covering only a portion of the surfaces of the bit of material 1000, either one or both of the photographic images 1001a and 1001b may cover an entire surface of the bit of material 1000.

FIG. 4a depicts a first surface of a bit of material 1100, displaying a photographic image 1101a. FIG. 4b depicts a second surface of the bit of material 1100 shown in FIG. 4a. The second surface displays a textual image 1101b. While the photographic image 1101a and the textual image 1101b are shown covering only a portion of the surfaces of the bit of material 1100, either one or both may cover an entire surface of the bit of material 1100.

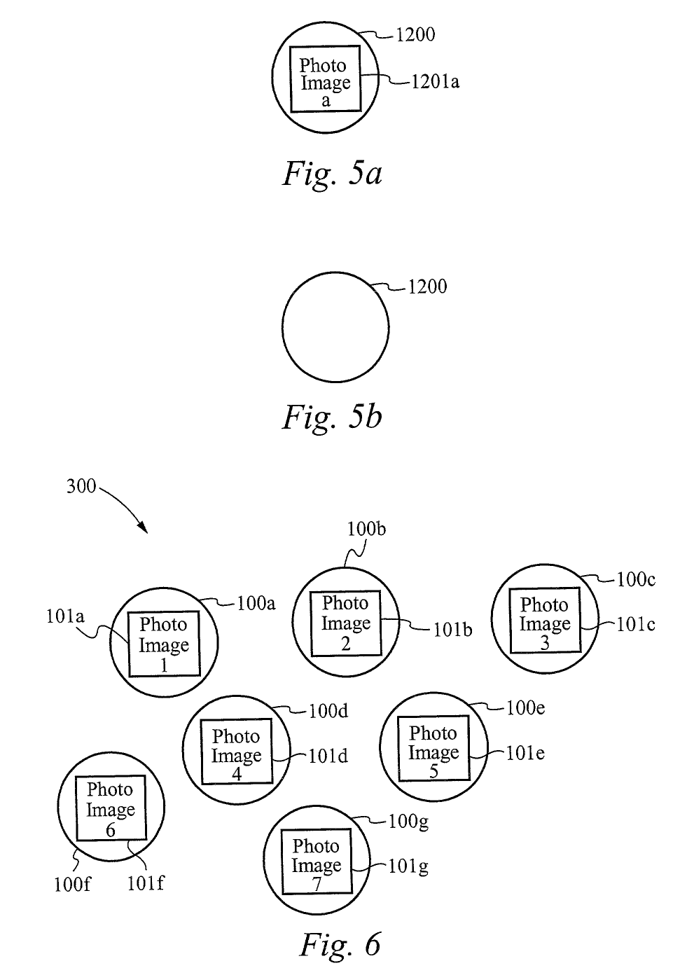

FIG. 5a depicts a first surface of a bit of material 1200, displaying a photographic image 1201a. FIG. 5b depicts a second surface of the bit of material 1200 shown in FIG. 5a. The second surface displays no image but may be colored. While the photographic image 1201a is shown covering only a portion of a surface of the bit of material 1200, it may cover an entire surface of the bit of material 1200.

FIGS. 3a-b, 4a-b, and 5a-b illustrate that bits of material in accordance with the present invention can have many combinations of photographic images, textual images, and no images on each surface of the bit of material. FIGS. 3a-b, 4a-b, and 5a-b do not exhaustively describe the shape and images displayed on customized bits of material in accordance with the present invention; it should be apparent to those skilled in the art that any combination of images and no images may be displayed on the surfaces of a bit of material.

FIG. 6 depicts a collection 300 of bits of material 100a-100g, each having a different image, 101a-101g, respectively, displayed on the face of each. Thus, for example, using the embodiment shown in FIG. 6 images relating to a person's life can be illustrated on a series of bits of material 100a-100g. One image 101a may show a person as an infant, a second image 101b may show that same person as a teenager, and a third image 101c may show that same person as an adult. Moreover, the same images 101a-101g as depicted on a first face of each bit of material 100a-100g or a different image may be displayed on the corresponding second face of each bit of material 100a-100g. While FIG. 6 depicts seven bits of material 100a-100g, a collection of bits of material may include more or fewer bits of material.

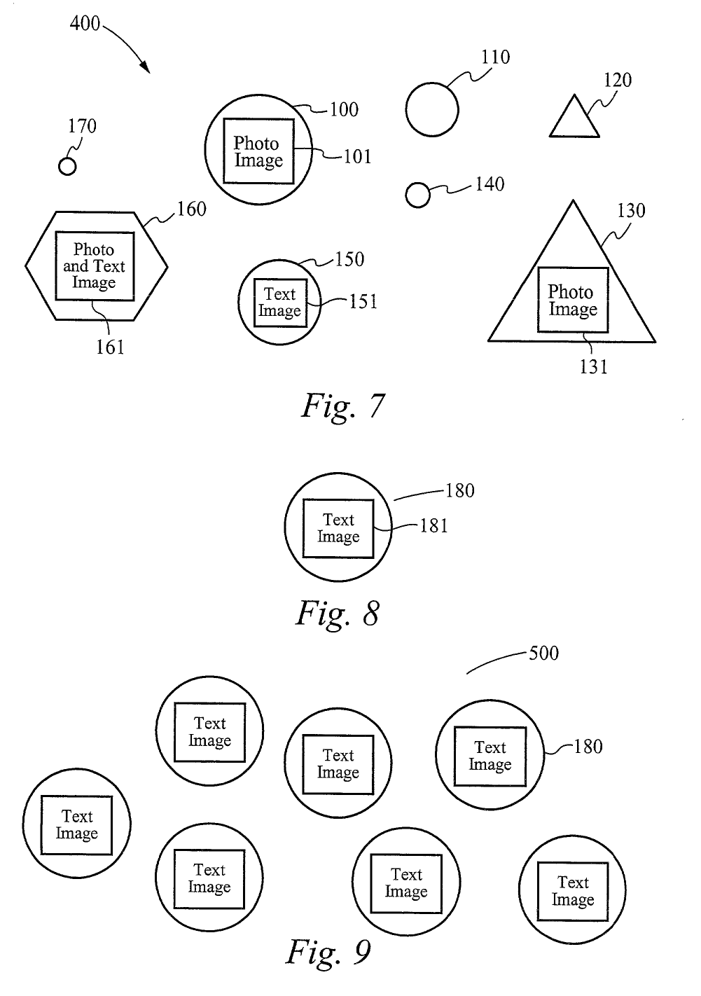

FIG. 7 is a further illustration of a collection of bits of material 400 in accordance with the present invention. The collection of bits of material 400 in this example contains bits of material having a variety of shapes and sizes, including the bit of material 100, displaying a photographic image 101 on a first surface; the bit of material 110 displaying no image on a first surface; the bit of material 120 displaying no image on a first surface; the bit of material 130 displaying a photographic image 131 on a first surface; the bit of material 140 displaying no image on a first surface; the bit of material 150 displaying a textual image 151 on a first surface; the bit of material 160 displaying a photographic and textual image 161 on a first surface; and the bit of material 170 displaying no image on a first surface. While the images 101, 131, 151, and 161 are shown covering only a portion of a surface of the bits of material 100, 130, 150, and 160, respectively, any combination of the images may cover an entire surface of the corresponding bit of material.

FIG. 8 illustrates a further embodiment of the invention in which a bit of material 180 has a text image 181 displayed on a face of a bit of material 180. The text image 181 can be a phrase, greeting, trademark, or any other text image. Furthermore, while the text image 181 shown covers only a portion of a face of the bit of material 180, it may alternatively cover an entire face of the bit of material 180. Moreover, the same or a different image, be it text, photographic, or a combination of both, may be displayed on a second face of the bit of material 180. FIG. 9 shows a collection 500 of the bits of material 180, shown in FIG. 8. While FIG. 9 depicts seven bits of material 180, a collection of bits of material may include more or fewer bits of material 180.

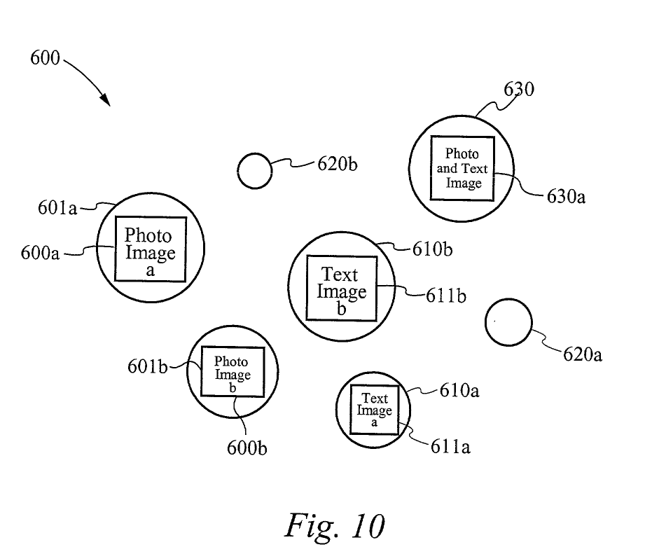

FIG. 10 illustrates a collection 600 of the bits of material 600a, 600b, 610a, 610b, 620a, 620b, and 630 of the preferred embodiment of the invention. The bits of material 600a and 600b have photographic images 601a and 601b on a face of each bit of material 600a and 600b, respectively. The bits of material 610a and 610b have textual images 611a and 611b on a face of each bit of material 610a and 610b, respectively. The bits of material 620a and 620b have colors on each of their respective faces, with no images. The bit of material 630 has an image 630a on its face, which has both photographic and textual imagery. FIG. 10 illustrates that the collection 600 can include any combination of bits of material having different images or colors displayed on their faces. Additionally, any combination of bits of material 600a, 600b, 610a, 600b, 620a, 620b, and 630 can have images on a second of their respective faces.

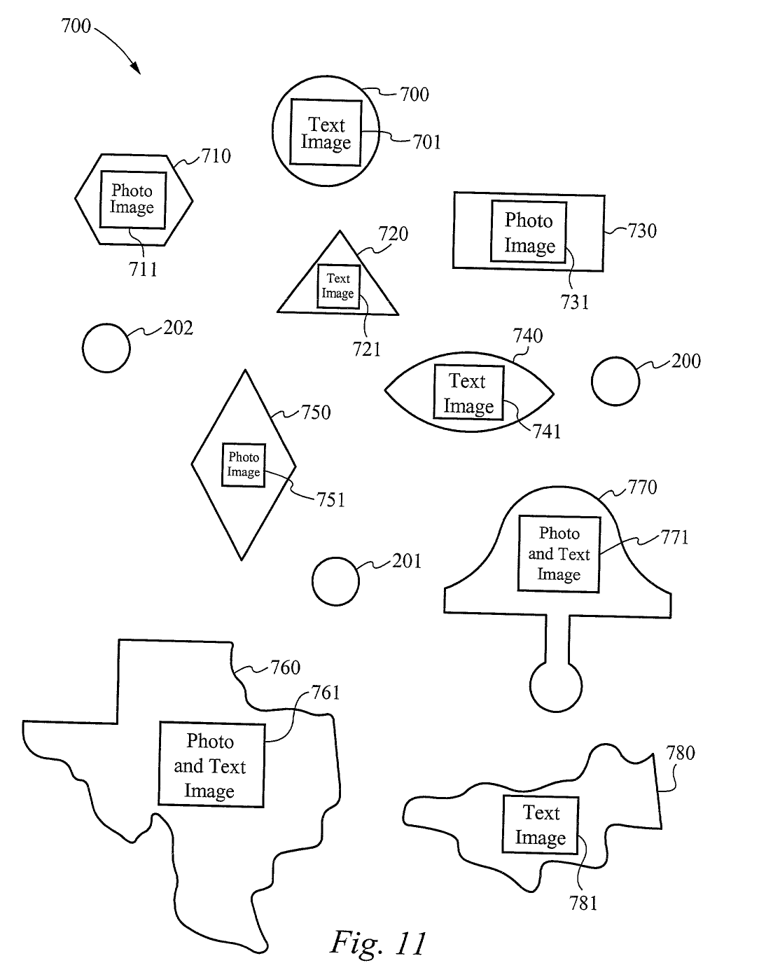

FIG. 11 illustrates a collection of bits of material 700 in accordance with the present invention. The collection of bits of material 700 includes geometric, non-geometric, and fanciful shapes. The collection of bits of material 700 includes a bit of material 700 displaying a textual image 701 on a surface; a bit of material 710 displaying a photographic image 711 on a surface; a bit of material 720 displaying a textual image 721 on a surface; a bit of material 730 displaying a photographic image 731 on a surface; a bit of material 740 displaying a textual image 741 on a surface; a bit of material 750 displaying a photographic image 751 on a surface; a bit of material 760 displaying a photographic and textual image 761 on a surface; a bit of material 770 displaying a photographic and textual image 771 on a surface; a bit of material 780 displaying a textual image 781 on a surface; and bits of material 200-202, displaying no image on their respective surfaces.

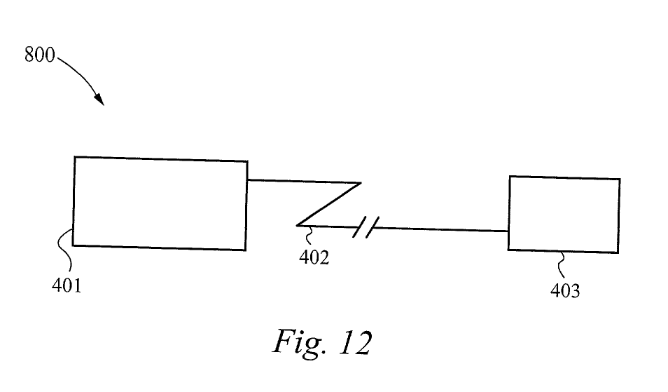

FIG. 12 illustrates a system for producing bits of material in accordance with the present invention. FIG. 12 will be described in relation to producing a collection of confetti, although it can be used to produce one or more customized bits of material not necessarily to be used as confetti.

The system 800 of FIG. 12 illustrates a selection/command processor 401, a transmission channel 402, and a confetti processor 403. As shown in FIG. 12, a user uses the selection/command processor 401 to choose an image that will be transferred to one or more faces of a piece of confetti. The selection/command processor 401 may include a computer terminal having a graphical-user interface (GUI) and a central processing unit (not shown). Using the selection/command processor 401, the user selects an image (the raw photographic image) to place on one or more faces of a piece of confetti. The raw photographic image may be selected from a library of images, including photographs, such as from a digital camera; it may be generated by a computer, input from a scanner, or generated by other means.

Using the selection/command processor 401, the user may generate processing commands and other information (collectively, metadata) used by the confetti processor 403 to process the image and thus create a processed image. For example, the processing commands may be codes that instruct the confetti processor 403 to crop the image to remove boundaries that have unimportant background images; and/or combine several separate images into one image, such as combining several photographic images or combining photographic images and textual images.

The metadata and the raw photographic image are transmitted over a transmission channel 402 to the confetti processor 403. If the selection/command processor 401 and the confetti processor 403 reside on the same network, the transmission channel 402 is a local area network. If the selection/command processor 401 and the confetti processor 403 reside on separate networks, the transmission channel 402 is a wide area network, such as the Internet. If the selection/command processor 401 or the confetti processor 403 does not reside on a network, but sits as a stand-alone piece of equipment, the transmission channel 402 is a wireless communications channel. If the selection/command processor 401 and the confetti processor 403 are directly connected, the transmission channel 402 may be a parallel cable or a serial cable, or indeed an internal bus if they reside on the same machine. In sum, the transmission channel 402 is any medium that allows for communication between the selection/command processor 401 and the confetti processor 403.

Next, the confetti processor 403 uses the transmitted metadata and the raw photographic image to generate a processed image, which is transferred onto a suitable material contained within the confetti processor 403. In a preferred embodiment, the material is paper. The material is then cut into pieces of confetti such that the pieces of confetti contain some selected portion of the processed image.

Several collections of confetti are preferably combined so that a final collection contains confetti bearing different images, colors, or both. Some collections, for example, may bear text messages.

In one embodiment of the present invention, the selection/command processor 401 is located at a kiosk, which may be located at a shopping center, grocery store, or other generally accessible place. A user will load digital photographic images from a portable storage medium, such as a compact disk on which her digital photographic images are stored, onto the selection/command processor 401 located at the kiosk. The user may load the digital photographic images using a kiosk-based scanner, operating-system copy commands, or any method used in transferring digital photographic images from one system to another. The digital photographic images may also be transferred from a location remote from the kiosk, such as from a remote file server connected to a network, onto the selection/command processor 401 located at the kiosk. Alternatively, the user may select stock digital photographic images available at the kiosk.

Using a graphical user interface on the selection/command processor 401, the user can then generate processing commands that instruct the confetti processor 403 to, for example, crop the raw photographic images, combine them to form other digital images, or add textual images to the raw photographic image. The raw photographic images are transmitted over the transmission channel 402 to the confetti processor 403, also located at the kiosk. Additionally, the confetti processor 403 may be located apart from the kiosk. Finally, the confetti processor 403 will generate the processed image or images, transfer them to a material with a confetti form factor, and cut the material into pieces of confetti.

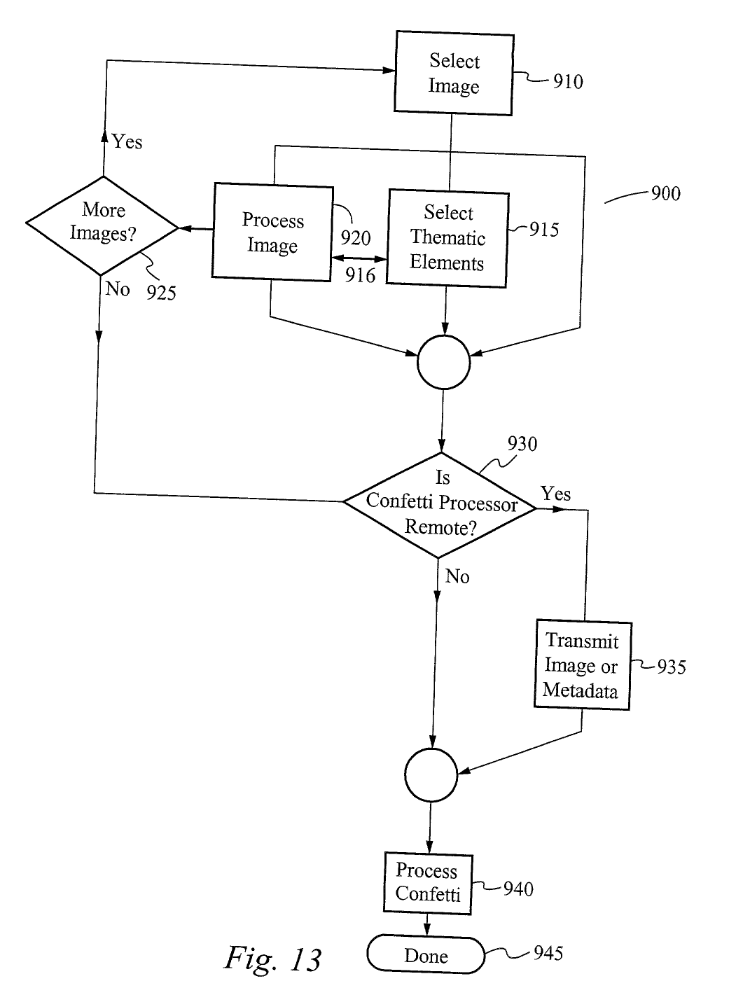

FIG. 13 illustrates a flowchart 900 depicting the sequence of steps that are preferably followed in producing a collection of confetti in accordance with the present invention. The steps will be discussed in relation to the selection/command processor 401, transmission channel 402, and confetti processor 403 illustrated in FIG. 12.

In the step 910 the user selects a raw digital photographic image that is to be displayed on the surface of a collection of pieces of confetti. The image may be selected from a set of images stored, for example, in a user library on the selection/command processor 401; the user may generate the image herself; the user may select images from a portable storage medium, provided by the user and downloaded to the selection/command processor. Alternatively, the images may be loaded from a scanner, or they may be transferred from a location remote from the selection/command processor 401, such as from a remote file server connected to a network. Alternatively, the user may select stock digital photographic images available at the kiosk. This stock may include stock photographs related to a movie, a singer, a sports team, a scenic view, a historic monument, or anything that can be displayed.

Next, the process proceeds to one of the steps 915, 920, or 930. In the step 915 the user selects thematic elements; for example, the user may select that the confetti be bell-shaped to celebrate a wedding. In the step 920, the user selects processing commands that the confetti processor 403 uses to process the digital images to generate a processed image. For example, these processing commands may instruct the confetti processor 403 to crop the image, that is, remove its borders or other non-essential portions of the image; they may instruct the confetti processor 403 to zoom out from or zoom in to portions of the image; or they may instruct the confetti processor 403 to alter the image in any way that changes the original image. As shown by the arrow 916, the user may switch any number of times between the step of selecting thematic elements 915 and the step of processing the image 920; accordingly, these steps shall be referred to collectively as the step 915/920.

Alternatively, from the step 910, the process may proceed to the step 930. At the step 930 the process determines whether the confetti processor 403 is remote from the selection/command processor 401. If it is, then the raw photographic image may be transmitted to the confetti processor 403. This reveals the asynchronous structure of the process in FIG. 13: the raw photographic image may be transmitted to the confetti processor 403 before the thematic elements or the processing commands (metadata) are transmitted. This structure uses transmission channel bandwidth more efficiently.

Alternatively, the process may proceed synchronously, by transmitting a raw image and metadata together.

At the step 915/920, the process determines whether there are more images to process at the step 925. If there are more images to process, the process proceeds to the step 910; otherwise the process proceeds to the step 930, as discussed above. Any combination of the steps 910, 915, and 920 may be performed asynchronously, that is, in parallel.

At the step 930, the process determines whether the confetti processor 403 is remote from the selection/command processor 401. If the confetti processor 403 is remote from the selection/command processor 401, then the raw data photographic data or the metadata is transmitted (whichever is being processed at the moment) over the transmission channel 402 to the confetti processor 403, and the process proceeds to the step 940. If the selection/command processor 401 and the confetti processor 403 are not remote, then the raw photographic data and the metadata already reside on the confetti processor 403, and the process proceeds to the step 940.

At the step 940, the confetti processor uses the transmitted metadata and the raw photographic image to generate a processed image. The processed image is then transferred to a material at the confetti processor 403 that is suitable for displaying the processed image. The processed image is then cut into confetti-like pieces. Alternatively, the processed image is transferred to a pre-perforated material at the confetti processor 403, preferably perforated into the shape of the final confetti-like product so that it can be transformed into confetti-like pieces with little or no cutting.

In the preferred embodiment, the material suitable for displaying the processed image is paper but any suitable material may be used. The processed image can be transferred onto the material using any appropriate method, including, but not limited to, laser printing, ink-jet printing, lithography, and any method that generates holograms.

As will be apparent to those skilled in the art, the images can be transferred to materials other than paper, including paper tissue, metallic foil, or polymeric layers. In addition, images can be transferred to both sides of the sheet of material before the sheet of material is cut into confetti. This may be accomplished in a way similar to that in which a photocopier or printer prints information on both sides of a sheet of paper. Moreover, the second side of each piece of confetti may contain selected portions of a larger image such that the second sides of the pieces of confetti can be arranged to display the larger image, much like a puzzle. This may be accomplished by transferring a large image to a second (“back”) side of a sheet of material so that it covers the surface area of more than one piece of confetti. When the sheet is cut up, the large image will be divided among several pieces of confetti; the image could be reconstructed by combining the pieces of confetti.

When the confetti processor has finished transferring the processed image to the material and cut the material into confetti-shaped pieces, the process is complete at the step 945.

After the sheet of paper is cut into confetti, a magnetic backing may be attached to a face of some or all of the pieces of confetti so that the confetti may be mounted or displayed, as appropriate. Alternatively, the paper may already have a magnetic surface before the images are transferred to it.

Adhesive surfaces may be attached to the confetti-shaped pieces of material so that they may be attached to other personally expressive items, such as party goods. Alternatively, the paper may already have an adhesive surface before the images are transferred to it. Furthermore, images of the confetti-shaped pieces may also be directly transferred to personally expressive items so that they may be displayed. For example, the confetti-shaped pieces of material may be attached to or transferred to napkins, greeting cards, paper cups, celebratory banners, children's game pieces, and many other items, limited only by one's imagination. The confetti-shaped pieces may be transferred to goods using printing methods, lithography, or any other method for transferring imagery.

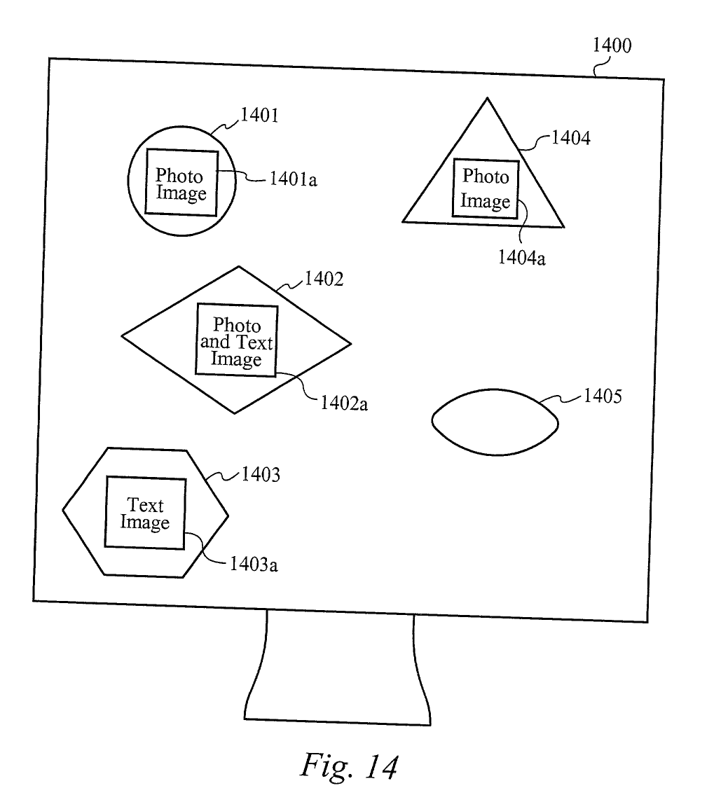

Representations of bits of material embodied in the present invention may also be electronically displayed. For example, FIG. 14 illustrates an electronic display device 1400 displaying an electronically generated representation of pieces of confetti 1401-1405. The electronically generated representation of pieces of confetti 1401-1405 may, for example, be an attachment to an electronic mail message. Alternatively, the electronically generated representation of pieces of confetti 1401-1405 may be stored in any number of ways in an electronic storage device.

While FIG. 14 shows an electronic display device 1400 displaying an electronically generated representation of pieces of confetti, it will be appreciated that a representation of a single piece of confetti may be displayed on display device 1400. The electronic display device 1400 displays: an electronically generated representation of a piece of confetti 1401, displaying an electronically generated photographic image 1401 a; an electronically generated representation of a piece of confetti 1402, displaying an electronically generated photographic and textual image 1402a; an electronically generated representation of a piece of confetti 1403, displaying an electronically generated textual image 1403a; an electronically generated representation of a piece of confetti 1404, displaying an electronically generated photographic image 1404a; and an electronically generated representation of a piece of confetti 1405, displaying no image but having an electronically generated color.

While the electronically generated representations of the pieces of confetti 1401-1405 are displayed in one position (statically) on the electronic display device 1400, the electronically generated representations may be electronically repositioned across the electronic display device 1400 to render a dynamic display. For example, the electronically generated representation of the pieces of confetti 1401 and 1402 may be exchanged to give a pleasing display; or the electronically generated representation of the piece of confetti 1401 may be temporarily no longer displayed on the electronic display device 1400, only to be redisplayed on the electronic display device 1400 within several seconds, possibly at a different position. Other electronic modifications are also possible. For example, the electronically generated representation of the piece of confetti 1401 may display a constantly changing photographic image that appears to a viewer as a motion picture. Accompanying audio, such as music or recorded greetings, may also be included in a file to which the electronically generated representations of the pieces of confetti 1401-1405 are attached.

While the electronic display device 1400 displays five electronically generated representations of pieces of confetti, fewer or more than five representations may also be displayed. Furthermore, three-dimensional and other renditions of confetti may be displayed on the electronic display device 1400.

It will be readily apparent to one skilled in the art that other various modifications may be made to the preferred embodiment without departing from the spirit and scope of the invention as defined by the appended claims.

We claim:

1. A collection of customized bits of material, comprising a plurality of bits of material, wherein each bit of material is customized with a photographic image.

2. The collection of customized bits of material of claim 1, wherein the photographic image is customized through selecting the photographic image from a set of photographic images.

3. The collection of customized bits of material of claim 2, wherein the photographic image is further customized through manipulating the photographic image.

4. The collection of customized bits of material of claim 1, wherein the plurality of bits of material are substantially the same size.

5. The collection of customized bits of material of claim 1, wherein a face of each bit of material has a surface area of no more than four square inches.

6. The collection of customized bits of material of claim 1, wherein each bit of material comprises a layer of paper.

7. The collection of customized bits of material of claim 6, wherein the paper is a tissue paper.

8. The collection of customized bits of material of claim 1, wherein each bit of material comprises a layer of a polymeric film.

9. The collection of customized bits of material of claim 1, wherein each bit of material comprises a layer of a metallic foil.

10. The collection of customized bits of material of claim 1, wherein each bit of material originates from pre-perforated media stock.

11. The collection of customized bits of material of claim 1, wherein each bit of material comprises a translucent material through which the photographic image is viewed.

12. The collection of customized bits of material of claim 1, wherein a source of the photographic image is digital.

13. The collection of customized bits of material of claim 1, wherein the photographic image comprises a computer-generated image.

14. The collection of customized bits of material of claim 1, wherein the photographic image comprises a text image.

15. The collection of customized bits of material of claim 1, wherein the photographic image comprises a hologram.

16. The collection of customized bits of material of claim 1, wherein each bit of material has a first face displaying the photographic image and second face, wherein the second face depicts a portion of a second customized image such that the plurality of bits of material can be arranged to display the second customized image.

17. The collection of customized bits of material of claim 1, wherein each bit of material is substantially a three-dimensional object.

18. The collection of customized bits of material of claim 1, wherein each bit of material has a second face with an adhesive backing attached thereto.

19. The collection of customized bits of material of claim 1, wherein each bit of material has a second face with a magnetic backing attached thereto.

20. The collection of customized bits of material of claim 1, wherein each bit of material has a geometric shape.

21. The collection of customized bits of material of claim 1, wherein each bit of material has a non-geometric shape.

22. The collection of customized bits of material of claim 1, wherein each bit of material has a first face displaying the photographic image and a second face customized with imagery.

23. A collection of customized bits of material, comprising:
a plurality of bits of material each having a first face, wherein each bit of material is customized with imagery.

24. The collection of bits of material of claim 23, wherein the plurality of bits of material are substantially the same size.

25. The collection of bits of material of claim 23, wherein a face of each bit of material has a surface area of no more than four square inches.

26. The collection of bits of material of claim 23, wherein each bit of material comprises a layer of paper.

27. The collection of bits of material of claim 26, wherein the paper is a tissue paper.

28. The collection of bits of material of claim 23, wherein each bit of material comprises a layer of a polymeric film.

29. The collection of bits of material of claim 23, wherein each bit of material comprises a layer of a metallic foil.

30. The collection of bits of material of claim 23, wherein each bit of material originates from pre-perforated media stock.

31. The collection of bits of material of claim 23, wherein each bit of material comprises a translucent material through which the customized imagery is viewed.

32. The collection of bits of material of claim 23, wherein the customized imagery comprises a photographic image.

33. The collection of bits of material of claim 32, wherein a source of the photographic image is digital.

34. The collection of bits of material of claim 23, wherein the customized imagery comprises a computer-generated image.

35. The collection of bits of material of claim 23, wherein the customized imagery comprises a textual image.

36. The collection of bits of material of claim 23, wherein the customized imagery comprises a hologram.

37. The collection of bits of material of claim 23, wherein each bit of material has a first face displaying the customized imagery and a second face, wherein the second face depicts a portion of a second customized image such that the plurality of bits of material can be arranged to display the second customized image.

38. The collection of bits of material of claim 23, wherein each bit of material is substantially a three-dimensional object.

39. The collection of bits of material of claim 23, wherein each bit of material has a second face with an adhesive backing attached thereto.

40. The collection of bits of material of claim 23, wherein each bit of material has a second face with a magnetic backing attached thereto.

41. The collection of bits of material of claim 23, wherein each bit of material has a geometric shape.

42. The collection of bits of material of claim 23, wherein each bit of material has a non-geometric shape.

43. The collection of bits of material of claim 23, wherein each bit of material has a second face customized with imagery.

44. A collection of confetti, comprising:
a plurality of unconnected pieces of confetti, each piece customized with imagery.

45. The collection of confetti of claim 44, wherein each piece of confetti is substantially the same size.

46. The collection of confetti of claim 44, wherein each piece of confetti has a face with a surface area of no more than four square inches.

47. The collection of confetti of claim 44, wherein each piece of confetti comprises a layer of paper.

48. The collection of confetti of claim 47, wherein the paper is a tissue paper.

49. The collection of confetti of claim 44, wherein each piece of confetti comprises a layer of a polymeric film.

50. The collection of confetti of claim 44, wherein each piece of confetti comprises a layer of a metallic foil.

51. The collection of confetti of claim 44, wherein each piece of confetti originates from pre-perforated media stock.

52. The collection of confetti of claim 44, wherein each piece of confetti comprises a translucent material through which the customized image is viewed.

53. The collection of confetti of claim 44, wherein the customized imagery comprises a photographic image.

54. The collection of confetti of claim 53, wherein a source of the photographic imagery is digital.

55. The collection of confetti of claim 44, wherein the customized imagery comprises a computer-generated image.

56. The collection of confetti of claim 44, wherein the customized imagery comprises a hologram.

57. The collection of confetti of claim 44, wherein each piece of confetti has a second face, wherein the second face depicts a portion of a second customized image such that the plurality of pieces of confetti can be arranged to display the second customized image.

58. The collection of confetti of claim 44, wherein each piece of confetti is substantially a three-dimensional object.

59. The collection of confetti of claim 44, wherein each piece of confetti has a second face having an adhesive backing attached thereto.

60. The collection of confetti of claim 44, wherein each piece of confetti has a second face having a magnetic backing attached thereto.

61. The collection of confetti of claim 44, wherein each piece of confetti has a geometric shape.

62. The collection of confetti of claim 44, wherein each piece of confetti has a non-geometric shape.

63. The collection of confetti of claim 44, wherein each piece of confetti has a second face customized with imagery.

64. A piece of confetti having a face customized with imagery.

65. The piece of confetti of claim 64, wherein the face has a surface area of no more than four square inches.

66. The piece of confetti of claim 64, comprising a layer of paper.

67. The piece of confetti of claim 64, wherein the paper is a tissue paper.

68. The piece of confetti of claim 64, comprising a layer of a polymeric film.

69. The piece of confetti of claim 64, comprising a layer of a metallic foil.

70. The piece of confetti of claim 64, comprising a layer originating from pre-perforated material.

71. The piece of confetti of claim 64, comprising a translucent material through which the customized image can be viewed.

72. The piece of confetti of claim 64, wherein the customized imagery comprises a photographic image.

73. The piece of confetti of claim 72, wherein a source of the photographic imagery is digital.

74. The piece of confetti of claim 64, wherein the customized imagery comprises a textual image.

75. The piece of confetti of claim 64, wherein the customized imagery comprises a computer-generated image.

76. The piece of confetti of claim 64, wherein the customized imagery comprises a hologram.

77. The piece of confetti of claim 64, being a substantially three-dimensional object.

78. The piece of confetti of claim 64, having a second face with an adhesive backing attached thereto.

79. The piece of confetti of claim 64, having a second face with a magnetic backing attached thereto.

80. The piece of confetti of claim 64, having a geometric shape.

81. The piece of confetti of claim 64, having a non-geometric shape.

82. The piece of confetti of claim 64, having a second face displaying a second customized image.

83. A method of producing a bit of material customized with imagery, comprising the steps of:
a. selecting an image from a set of images;
b. processing the selected image to produce a customized image; and
b. transferring the customized image onto a face of a bit of material.

84. The method of producing a customized bit of material of claim 83, wherein the bit of material is a piece of confetti.

85. The method of producing a customized bit of material of claim 83, wherein the step of processing the selected image comprises the step of cropping the selected image.

86. The method of producing a customized bit of material of claim 83, further comprising the step of transmitting the selected image and data corresponding to the processing of the selected image over a communications channel.

87. The method of producing a customized bit of material of claim 86, wherein the communications channel comprises a wide area network.

88. The method of producing a customized bit of material of claim 86, wherein the communications channel comprises a local area network.

89. The method of producing a customized bit of material of claim 86, wherein the communications channel comprises a wireless network.

90. The method of producing a customized bit of material of claim 83, wherein the set of images comprises photographic images.

91. The method of producing a customized bit of material of claim 90, wherein the photographic images are digital.

92. The method of producing a customized bit of material of claim 83, wherein the set of images comprises computer-generated images.

93. The method of producing a customized bit of material of claim 83, further comprising the steps of selecting a second customized image and of transferring the second customized image onto a second face of the bit of material.

94. The method of producing a customized bit of material of claim 83, wherein the step of transferring the customized image onto a face of a bit of material comprises transferring the customized image onto a pre-perforated material.

95. A personally expressive item displaying a representation of a piece of confetti having a face customized with imagery.

96. The personally expressive item of claim 95, wherein the face of the piece of confetti has a surface area of no more than four square inches.

97. The personally expressive item of claim 95, wherein the piece of confetti comprises a layer of paper.

98. The personally expressive item of claim 97, wherein the paper is a tissue paper.

99. The personally expressive item of claim 95, wherein the piece of confetti comprises a layer of a polymeric film.

100. The personally expressive item of claim 95, wherein the piece of confetti comprises a layer of a metallic foil.

101. The personally expressive item of claim 95, wherein the piece of confetti originates from pre-perforated material.

102. The personally expressive item of claim 95, wherein the piece of confetti comprises a translucent material through which the customized image can be viewed.

103. The personally expressive item of claim 95, wherein the customized imagery comprises a photographic image.

104. The personally expressive item of claim 103, wherein a source of the photographic imagery is digital.

105. The personally expressive item of claim 95, wherein the customized imagery comprises a textual image.

106. The personally expressive item of claim 95, wherein the customized imagery comprises a computer-generated image.

107. The personally expressive item of claim 95, wherein the customized imagery comprises a hologram.

108. The personally expressive item of claim 95, wherein the piece of confetti is a substantially three-dimensional object.

109. The personally expressive item of claim 95, wherein the piece of confetti has a geometric shape.

110. The personally expressive item of claim 95, wherein the piece of confetti has a non-geometric shape.

111. An electronically generated representation of a piece of confetti for display on an electronic display, wherein the piece of confetti is customized with imagery.

112. The electronically generated piece of confetti of claim 111, wherein the surface area of the electronically generated piece of confetti is no more than four square inches.

113. The electronically generated piece of confetti of claim 111, wherein the imagery comprises a photographic image.

114. The electronically generated piece of confetti of claim 112, wherein a source of the photographic image is digital.

115. The electronically generated piece of confetti of claim 111, wherein the imagery comprises a textual image.

116. The electronically generated piece of confetti of claim 111, wherein the piece of confetti is rendered as a three-dimensional object.

117. The electronically generated piece of confetti of claim 111, wherein the piece of confetti is rendered as having a geometric shape.

118. The electronically generated piece of confetti of claim 111, wherein the piece of confetti is rendered as having a non-geometric shape.
